(19) United States
(12) Patent Application Publication
(10) Pub. No.: US 2013/0035996 A1
(43) Pub. Date: Feb. 7, 2013

(54) SOCIAL ADVERTISING TECHNOLOGY (SO-AD-TEC) SYSTEM AND METHOD FOR ADVERTISING FOR AND IN DOCUMENTS, AND OTHER SYSTEMS AND METHODS FOR ACCESSING, STRUCTURING, AND EVALUATING DOCUMENTS

(71) Applicant: Tim Frey, Hassmersheim (DE)

(72) Inventor: Tim Frey, Hassmersheim (DE)

(21) Appl. No.: 13/580,973

(22) PCT Filed: Feb. 24, 2011
(86) PCT No.: PCT/EP2011/052729

§ 371 Date: Oct. 15, 2012

(30) Foreign Application Priority Data
Feb. 25, 2010 (EP) 10001967.8

(51) Int. Cl. G06Q 30/02

(52) U.S. Cl. 705/14.4

(57) ABSTRACT

The invention relates to system to access advertisement and/or associated information that can be stored in a So-ad-tec system. The So-ad-tec system includes an access unit which is designed to process at least one access having resources to access details of at least one schema or the information derived thereof or the schema (120) or the structure itself. The So-ad-tec system is designed to manage advertisement and other associated or related information, in at least one schema.

### CROSS REFERENCE TO RELATED APPLICATION

This application is a national stage entry of PCT/EP2011/052729 filed Feb. 24, 2011, under the International Convention claiming priority over EP Application No. 10001967.8 filed Feb. 25, 2010.

### FIELD OF THE INVENTION

This invention is related to a system and method for advertisement by and in documents as well as for associating products in or to the documents. Moreover, the disclosed techniques, systems and methods of the invention also cover areas of applications that may be used in relation to the general access to documents or systems as well as for structuring and associating knowledge.

### BACKGROUND OF THE INVENTION

At present, there are several sites and search engines on the Internet, which achieve their profits by playing advertisements. Therefore, it is desirable to display an accurate advertisement that interests the user in such a way to increase the likelihood of a positive response from the user. Besides, today, the Internet is extremely dynamic. For instance, the content of users may be changed, added or deleted at several places. Also, various resources are perceived differently by different users. Thereby, observing this fact in terms of advertisement is also a challenge.

Facebook (http://www.facebook.com/) is an Internet website, a Social Network to be more precise, which allows adding tags to images. Here, those tags should be relate to people. If Tag is specified a work, which does not matches any person, then you will be prompted to enter an E-mail address matching to the person. Often, this is also known as “linking persons”. Studivz (http://www.studivz.net/) Meinvz (http://www.meinvz.net/), Wer-kent-wen (http://www.wer-kennt-wen.de/) and other social networks are designed similar to Facebook. Here, the advertisement is often at the borders and is not related to the content of the page that is being visited. There is an option in Facebook that the companies or political figures may create a profile and the user can become their fan. But it is not possible to link this “special profile” as virtual people.

Flickr (http://www.flickr.com) is an Internet website, which allows you to upload and edit photos. It is also possible to mark areas in photos and add comments. A disadvantage here is that products cannot be “linked”.

U.S. 2008/0126226 A1 (http://www.mirriad.com/) requires a method to prepare videos for distribution, whereby the videos are analyzed to define placement zones where ads can be placed. By means of placing zones, it is possible to embed new advertisements into videos. However, the problem of logically incorporating suitable advertisement to the context of the video remains unsolved.

US 2008/0086368 A1 is a system and method for site and content-based online advertising. This requires a method for determining the context of advertisement on the basis of received content, for determining a geographical region and for determining a display, which is assigned to the advertising context and their sketches by a marker in one of the card determined on the basis of geographical region. The disadvantage of this method is that which advertisement will be assigned is decided purely on the basis of the content. This prevents identification of conclusions via classifications and assigning advertisements based on it. For instance, the information that a ski helmet is part of ski equipment cannot be used while assigning. Moreover, the fact that documents often exist in several contexts is often neglected. The method is designed for a one-time receipt of content. It neglects the fact that often receiving content several times could be useful. Furthermore, it is not possible to use the content information in further received contents. Another problem is that a context is exactly assigned to one display and not to several. This prevents evaluation of multiple advertisements that match the content and determine which one matches best.

WO2004/029758 a2 is a method for assessing the relevance of advertisement to the content of a document based on the before mentioned analysis of the contents of advertisement and the document as well as the comparison of the specific issues in the analysis. Thereby, an issue which is usually knit in such a way that, for example, if there is a document to containing the report of a Skoda Octavia with its four wheels and rims, the advertisements of other cars is deemed relevant since it also has several themes of the document, such as car, wheels or rims. Significant effects of these problems are thus to be considered by the advertiser. It may happen that an advertisement of a competitive product may be exchanged in an is article via one of his products. Thereby, the issues are not related and it is now possible to exclude certain words. This or similar form of advertising are often also called as Keyword Advertising.

US 2009/0171748 A1 describes how product information and data may be used in social networks to improve online advertisement. For this purpose, a content object which displays advertisement is determined and delivered based on the request of a user interface. This is determined at least on the basis of a category to which the user belongs in terms of a social network, and to a product type. Wherein each category represents a position in the social network and the activities of the user associated with the type of product.

This invention does not solve the problem of incorporating relevant advertisements for the currently displayed content. Rather, it finds a suitable product based on the position of the user in social network and does not determine the products that fit the currently displayed content. Thus the fact that the content relevant advertisement works much better, is ignored.

U.S. 2009/0171763 A1 describes an advertisement request machine, which selects advertisements that may be predicted as interesting for the user. This prognosis is based on a memory unit in which a multitude of advertisements are stored, that are predicted to of interest to a user. This is done on the basis of compliance with the multitude of previously delivered advertisements. The limitation here is that the prediction is done only on the basis of previously delivered advertisements and not on the basis of contents being considered by the user.

US 2008/0092159 A1 describes a method for target advertisement by videos. In the process, a promotional item is transferred for advertisement and it is determined whether these promotional items were skipped. Thus the profile of the viewer is updated, and it is saved whether the promotional product was skipped or not. The disadvantage of this method is which promotional items do not interest the user is not stored in relation to the advertised product group. Another problem is that the information on skipping is not combined with other information. The advertisement may be classified as skipped or not skipped only after skipping and there is no prediction on skipping.

Semantic advertising is the semantic analysis of the content of documents on the Internet and display of advertisements semantically relevant to the content. Until now, attempts have been made by speech analysis and machine learning to detect the semantic content of documents. For instance, by http://www.peer39.com/ or iSense (http://www.isense.net/). ISense pursues the target of understanding and analyzing a website and its content. In order to accomplish this, Isense has an ontology, which allows classification a Web page in one of 3000 different categories. A problem with these semantic solutions is that it fails to observe that the users are different and contents are subjectively interpreted. Furthermore, the advertiser does not has the option to classify his product or his advertisement nor arrange them into the system. In addition, the website is analyzed on the basis of the schema and not as per advertising. Another problem of this method and apparatus is that these are slow and work with highly complex schemes. Thereby it is set to understand everything and not the content that is relevant to the user. Furthermore, a stored ontology is absolute. It is allowed to ignore the fact that users may have a different perception.

U.S. Pat. No. 7,617,121 B1 (Intellitxtsm von http://www.vibrantmedia.com) describes a devices, which displays the hyperlinks on the advertisement to add different words in a content. A problem with this solution is that the hyperlink is created only on the basis of one or more words that have been selected by the advertiser. Thereby, complex assignment is not provided for categories.

US 2007/0124208 A1 describes a system and method to tag to data. Thereby, classification data is collected in a distributed computer system, whereby at least one part of the classification data classifies content. Then the content is processed on the basis of classification. The disadvantage of this solution is that the classification data will not be used to assign the content to the advertisement. Furthermore, the classification is data is not used to form conclusions about the content.

WO 2004/079522 describes the identification of a specific content-related information and/or presentation of related information in terms of content-related advertisements. Thereby, the document information is used to determine additional content of the document to at least combine one part of the document content with the specific content for presentation to the user, wherein the document contains at least one advertisement. It can only determine the advertisement for one document and not several. Moreover, the document information will only be received. It remains unresolved how the document information is created and how semantically relevant advertisements can be as incorporated into the document. In addition, the particular advertisement may only be used for presentation purposes. This is a great limitation, because only the presentation is known as target. There is another problem that the content does not has any direct effects on the presentation, i.e. the type of presentation cannot be changed on the basis of content, for instance, by certain words that are processed or selected differently by the advertisement graphically, such as an image or video.

US 2008/0086356 A1 describes a computer-implemented method for determining the relevance of demand for advertising. In the process, map-based location information, which is linked with the request, is compared to the target location information of the advertisement and the relevance is determined thereof based on at least one advertisement from comparing card and target-based location information. The limitation of this method is that the direct location information must be transmitted. It is not possible to indirectly transfer the information associated with location information and determine the location information from it in the method. For instance, the references to images entered at a certain location. Or even a product that can be purchased at certain locations. The disadvantage of this solution is that the invention does not has the resources to directly and logically link the location information location with other data.

EP 1567961 illustrates a method and system for providing an is advertising listing variance in distribution feeds over the Internet to maximize the revenue for advertising distributor. In the process, it provides a hyperlink and a bid linked with it to determine the payment to be made by the advertisers when selected by a user. Apart from this, the advertisement distribution system can enhance the advertisement on the basis of performance efficiency. The advertisement distribution system thereby contains resources to receive at least one advertisement, with a special distribution theme and an order which is specified as per click delivery. Moreover, it also has resources for sorted lists of advertisements on the Internet, in which the advertisement list consists of a range of advertisements. In addition to this, such a list is sorted for delivery by evaluation resources on the basis of a distribution theme and the click rate is regulated by performance efficiency. This invention has a disadvantage that the advertisement is not sorted into a complex category scheme. Thus, for instance, hierarchies of specializations are not determined. It is not possible to generalize about topics and determine suitable advertisements. Another limitation is that the actual user is not observed in terms of advertisement, because the interests of users may differ.

EP 1547118 reveals a method and system for providing filtered and/or masked advertisements on the Internet. In doing so, the system has resources to receive a request for advertisement lists based on request term and a filter that may be applied to advertisement list can be excluded on the basis of specific characteristics. The resources for filtering are used to exclude the lists of advertisements from a database of potential advertisement lists that are linked with the request term in order to generate a filtered set of advertising lists. In addition to this, the system has advertisement list delivery resource that can deliver one or more advertisement lists on the basis of filtered quantity. The disadvantage of this solution is that advertisements cannot be excluded on the basis of advertisement categories. Another limitation is that such a system can process only one request term.

EP 1522034 providing advertisement through content-based nodes over the Internet reveals an internet advertising system, which receives advertisement information from advertisers for release by a hierarchical, content-based multiple node system. In the process, this system has receiving resources that can obtain information on advertisement lists. One or several nodes can with which the advertisement should be linked can be selected by this receiving means. Moreover, the amount of an associated offer is specified. The final user can retrieve a special node based on the publication means, wherein the content of the node and the corresponding advertisements, associated with the node, are delivered. The disadvantage of this invention is that the advertisement is integrated into a purely hierarchical structure. This makes it impossible to cover nodes that are similar to the current content for detecting related advertisements. Furthermore, such a system has one hierarchy and not many. But often, the perception of people differs and they would build a different hierarchy. Other limitations result from the limitation on a hierarchy and due to the negligence that different users have different perceptions.

US 2006/0242013 A1 describes a method of recommending target information for advertising. In the process, first of all one or several keywords are accepted and one or several taxonomy categories are determined by at least one keyword. A limitation of this invention is the restriction of words. For instance, image section is not shown on the recommendations of a taxonomy category or by a keyword that represents response. Another problem is that non-similar taxonomy categories may be determined.

This invention is therefore based on the technical problem of providing a system and a method, by which the advertisement and the related information can be accessed and combined in a structured, flexible and user-centered way to overcome the above mentioned disadvantages.

### SUMMARY OF THE INVENTION

This problem is resolved as per the initial aspect of invention by a So-ad-tec System for accessing the advertisement. A So-ad-tec System exhibits the following in the style as per the patent claim 1:

An access unit that is designed to process at least one access, wherein one such access may contain resources that are used to access at least one schema from the information or the details derived thereof or the schema or its structure;

whereby a So-ad-tec system is designed to regulate advertisement and other information associated with it in at least one scheme.

According to this, the present invention represents a So-ad-tec System, which enables structured access to the advertisements. Here, the access implies writing, reading or evaluating/determining information from the schema, even in combination with data from access. Currently it is not possible to access structured and or logically related information such as user and context data due to the complexity of advertisement and the information associated with it because these data may be distributed in different systems (such as, in a computer network like the Internet, which has myriad social networks). Therefore, this invention introduces the concept of schemata, in which advertisements can be structured. This allows flexible storage of advertisement information in a So-ad-tec System and may be combined with other data. Such a schema makes it possible to structuring of all relationships, even complex with regards to advertisement and other information. In the process, there is an option for advertisers to store new information such as categories, or advertisements and offers or inference rules easily and flexibly. In addition, such a schema also allows information to be stored in terms of requests and/or evaluations and other input information.

The structure of the advertisement is also not firmly specified from the status of technology and cannot be changed. Rather, the logical structure where a product is located can be detected by such a schema. Moreover, it is possible to store information, by which other information and products should show a product or as an advertisement.

In contrast to the state of art technology, the rules of assessment are not fixed on how suitable advertisement shall be determined. Nowadays, only one assessment rule is specified. Hereby, a So-ad-tec system is more flexible. Several rules can be stored and combined in a So-ad-tec system. Currently, even an advertiser cannot distinguish whether it represents a reference source or a brand. For example, an automobile manufacturer is a brand that does not represents any reference source. A schema solves such problems.

Another advantage is that a So-ad-tec system is not determined as source or target in the media form of advertisement. Rather, various types of advertising, such as text, images, video or audio and other types of documents and representation can be realized.

These new range of options provide a particularly efficient and accurate delivery of advertisement. It is now possible to observe a variety of information and relate them to only one information type and not as known. It is now possible to connect different information, such as user profiles, the context data and the structure of the advertising with each other.

In another aspect of the present invention, a So-ad-tec System has a storage unit which enables storage of received information or integration in a schema. In the process, the storage may be distributed across several systems. Another special feature is that here, only advertisements are not stored, but also other information. For instance, categories, rules, and/or other complex structures.

Other range of applications is also possible by the storage unit. Thus, a So-ad-tec System has resources, which allow utilization of data from the storage unit. For instance, the, information on past requests or operations may be filed in these data. The resources for utilizing these data can be used to determine which advertisements are best suitable to the access documents, also on the basis of previous access, for instance. Such as by interest reviews.

Thereby, in contrast to the best available technology, it is possible to use a context not only for a website to determine advertisement, but also pages, visited before can be included while determining an advertisement. Such or similar methods also allow the use in other areas, such as Search engines. Thereby, relevant search results or advertisements are determined on the basis of previous search results in the memory. For instance, if a user searches a term and does not receives a satisfactory result. Then he will modify the search parameters or terms. The primary interest or the interests of the user can be identified on the basis of terms, topics, categories or other elements that appear again and again. This can be used to determine particularly suitable advertisements thereof or even to present better search terms and/or results, which are actually sought by the user.

Furthermore, a So-ad-tec System has at least one hierarchical schema. In such a schema, products are arranged in categories, for instance. Thus advertisers can not only advertise directly for individual words, but also for categories. Since So-ad-tec may have several such schemas, this enables a much more precise control than the advertising systems used today, in which, the advertising is based on words or topics and hierarchies are not considered. The advertisers may also determine if they would like to advertise the elements existing deeper in the hierarchy.

It can also be used in other fields, especially as system or method to enable selection of products in documents, especially in videos or images on the basis of the properties of the present invention. Nowadays, people can often mark personal or general fields in images with tags, which are not purely textual and cannot be used as classification. By So-ad-tec system, it is not only possible to mark these areas, but rather by generating references to products by tags. This allows distribution of document contents in tags to detect and be linked with one or several schemas in a new type and way. For the first time, other information can be “linked” as people, especially in social networks. Thereby, for instance, clothing products are also represented and completely new applications or analyses can be realized. For example, “who is wearing what?”? A special feature of the So-ad-tec system is the ability that the documents of the user can be stored in the system for easier marking.

Apart from this, a So-ad-tec system uses context data during access. Such context data may be tags, for instance. Thus it is possible to retrieve advertisement on the basis of tags. Through this innovation, it is is possible to implement new options of applications and new types of “Product Placement”. Thus, it is allows marking images and then suitable tags to display advertisement, for example. This opens a completely new distribution channel to the advertisers, since previously non-documents such as private images of people could be assigned on social networks.

Particularly beneficial is the ability of So-ad-tec system to consider more data, except context data. This is very valuable because context data and user data can be simultaneously observed. This makes it possible to perform much more complex assignment of advertisements to documents than it is possible today. For instance, decisions on which content interests the user can be taken by the user data from his profile. This allows user-focused and contextual advertisement. If in doing so, further information such as how hierarchies are incorporated may be used from the schema to determine the most efficient and relevant advertising.

Previous executions may also be used to write the data directly or indirectly into one or several schemata as well as in other storage units. A great advantage here is that this data can be used in new queries. For example, it can be stored that users ignore advertisement if they appear with certain contexts. The efficiency of advertisement can be enhanced further by using such access information.

Another advantage of a So-ad-tec system is that it does not have any inflexible and unchangeable schemas. A special feature of the scheme is that it does not have any fixed unchangeable structure, but rather can be changed at runtime. This allows a very flexible and quick adjustment to new situations. It is particularly useful, because due to this, the schema is kept up to date and further information can also be recorded.

It should be noted that a So-ad-tec system can also have detectors that can help detecting products in documents. These are particularly useful in terms of advertising. Especially, the ability to combine them with human capabilities. For example, to exercise such detector or to verify their results.

Another feature of the So-ad-tec system is analysis, which may also be used regardless of a So-ad-tec system to create or optimally adjust the schemata.

Another feature is the Nexus node system or methods, which may also be used amongst others, in combination with the So-ad-tec system or even without it. This can be used for referring to an advertisement or as schema. Thus, a Nexus node system solves the issue that currently in the Internet, hyperlinks (hereinafter abbreviated to link) refer to exactly one resource and the last URL of the link target must be known to the user while creating. A Nexus node system features following in a style:

At least one node management unit, which enabled administration of at least one node, which can be addressed through reference in documents;

Whereupon, a node can refer to one or several targets and a node can have function of a substitute for further resources.

Thereby, the user receives the option to set flexible reference to resources in a computer network. In the process, a node, hereinafter known as Nexus or Nexus notes must not be explicitly created, but automatically emerges virtual when referred to it. A great advantage of this solution against the best available technology is that the target address may be still unknown to the users but still a reference to associated documents or even topics can be set in a document. The real target may be later recorded with high flexibility by Nexus nodes. In addition to this, it is possible to simultaneously refer multiple resources, which is not possible with existing technologies, for example, such as hyperlinks. Furthermore, it allows a significantly easier set up of Nexus Node references use, than according to the best available technology. It is thereby possible to use smart short forms by simple grammatical rules, which fits better than hyperlinks for human speech. In addition to this, it can be automatically replaced by links. In the process, the smart detection methods may also be used. For instance, by short reference to “my: car”, which is possible by a grammatical rule is automatically triggered and is determined by the use from “my”. Primarily, an option is available for the user with the function of product to express the reference to his possessions, for instance. This is a great improvement to the widespread Hyperlink Technology, since there are references similar to those in Wikipedia on the Internet but these must not be restricted to only one target resource.

Nowadays, we face a problem in distinguishing whether a user is a human or a machine. In order to answer this question, often a text or audio-based CAPTCHA test (http://de.wikipedia.org/wiki/CAPTCHA) is used. In the process, there is an issue that human labor is used, without using them and the text-based CAPTCHAs are more difficult to be solved by humans because of improved efficiency of OCR software. reCAPTCHA (http://recaptcha.net/) solves the issue that human labor loses, in which the texts are digitized. However, there is a problem of increasingly difficult legibility. Therefore, there is a technical problem of providing an effective replacement for text and audio-based CAPTCHA. This task is achieved by a SCAPTCHA (smart CAPTCHA) system or method. In one model, a SCAPTCHA features:

An access determiner for at least one decision on at least one access, based on the response of at least one captcha;

wherein the solution/response to the captcha can be used to gain information and such information at least has another purpose

Thus the OCR can be performed not only by the user but several human skills are to be used. This makes it possible to recognize objects, such as animals, or even special animals on images. Then these data could be used as context data for a Sa-ad-tec system. By such a system, people also solve tasks such as identifying categories or relate each other or evaluate ratios with each other. In addition, the user information is recognized in images and thereby aids in adjusting schemata. Or human labor is used to create complete schemata or to adjust. Such a system or method can be especially used for images and videos, wherein it is even possible to combine technical and human intelligence. It is also possible to use this system for speech recognition. These tasks have the advantage that the user can easily solve them but a computer has huge problems in is solving them. Furthermore, it is now possible to identify rules that a person uses by means of captcha. Totally in contrast to the best available technology, it is now possible to implement other methods rather than the only recognizing letters or numbers. In addition, it is now possible to use the answers not only for a captcha but also for something beneficial. Thus, this invention reveals a SCAPTCHA system, a device and a method that enables provision of human performance, which is used in verifying humans.

Furthermore, such a system has an evaluation unit, which allows recognizing whether one or several solutions were responded by people or machines. This makes it possible to use this recognition for deciding on the access and expands the system, which previously took decisions on access only on the basis of solutions.

It is to be noted that captcha may also be solved by different users. Thereby, it is also possible to determine the likelihood for responses. It also includes other means, such as those presented in this document like user information. Usually, the resources can also be used for analysis. As a result, the responses of the user can be processed well and the reorganization rate of humans and machine can be further refined by observing these factors.

Apart from this, the content of captcha or the captcha itself can use further details while determining. This could be user or context information for instance, wherein one such captcha appears. This can be used for better evaluation of captcha result, for instance. It is also possible to create captcha, which are customized for a user or have an advertising effect. Usually, it is possible to use all the resources and methods of a So-ad-tec or a Nexus node system to determine a captcha or its content.

The utilization of information from SCAPTCHA system is also beneficial to adjust or create one or several schemata. Thereby, it is possible to evaluate the intensity of the relations in the schema or organization into hierarchies as well as classification of other types of relations. This makes it possible to create or improve those schemas which correspond to the human perception and sense, by means of this system.

Thus system can also be used in other areas. If the skills of the user are known, they can be used to capture expertise in schemas. Furthermore, such a system can be used to train systems/methods. For example, the detectors described in this document. Here, the range of applications is possible, in which human skills can be combined with those of a machine. For example, a person recognizes a mobile phone in an image. The verification whether the area is correctly marked is performed by an algorithm. Due to this, the entire image must not be analyzed, but rather a part of the field and it also saves processing power and energy.

Basically, this system can be used in social networks as well as in forums. Usually, the range of applications of the Internet or other computer networks is preferred even on mobile handsets. In doing so, the captcha is delivered to the user via channels, which are responded and a technical device transmits the answer to the system. In general, such a system can be created as a distributed system with same functions.

Lastly, this invention provides a computer program including the instructions to perform any method described herein.

### BRIEF DESCRIPTION OF THE DRAWINGS

FIG. 1: A So-ad-tec System with one or several schemata according to a model of the present invention;

FIGS. 2-3: Method of a So-ad-tec System according to a model of the present invention;

FIG. 4: A So-ad-tec System according to a model of the present invention;

FIG. 5: An advertisement structure access unit according to a model of the present invention;

FIG. 6a-e: Sample Schemata;

FIG. 7: Example for developing interest over a period;

FIG. 8a-9b: Example for possible connections of nodes in Schemata;

FIG. 10: Interaction of a So-ad-tec System according to a model of the present invention;

FIG. 11: Example for a medium marked by tags;

FIG. 12: A SCAPTCHA System and interactions according to a model of the present invention;

FIG. 13: A Nexus node System according to a model of the present invention;

FIG. 14: Interaction of a Nexus node Systems according to a model of the present invention;

### DETAILED DESCRIPTION OF THE INVENTION

This invention generally concerns a model of advertising on the Internet and especially the determination of advertising for one or more documents 10. Here advertisement includes any elements/artifacts such as those occurring by human communication in the context of advertising. For instance, the advertisement which gains favor refers to similar or further websites to influence decisions, trigger responses or even to advertise a partner or to create interest. Furthermore, the advertisement relates to business terms of the advertisement which is targeted to advertise something. Advertisement can thus be seen as much more than advertising means which can be used to trigger a response or/and to influence. Thus it includes even other advertising means such as propaganda, opinion and image cultivation, proselytisation, improving reputation, purchase suggestions, urging and philandering.

Often an advertisement contains a specific product. Thereby, a product can be a person or his product and even a place or the like, an object, an idea or thoughts. Therefore, a product may not be absolutely real. Examples of products can be goods/articles, manufacturer, brands, political ideas, reform ideas, methods, ski-region, daily commodities, luxury goods, networks—electronic and natural variety, theme parks, shops, documents 10, URLs or equipments, in short, everything that may awaken the need of people and partakes to use or buy them.

The concept of advertising also includes the concept of advertising data. Advertising data can be the advertisement itself, the product, the manufacturer or any other means, which are used for describing the advertisement. For instance, the products that can be classified into the same category. Thus, advertisements are documents 10 or other forms including means to generate interest to promote a product. Advertising data may contain other resources or data that can accurately describe the probability of showing products at certain places or other data that occurs in relation to the advertisement for products and manufacturers. Often, the term advertisement list emerges in relation to advertising, which contains a collection of advertisements, especially those advertisements that may be structured according to the relevance. Furthermore, it is also possible that this list may not be a list in original aspect, but rather a collection of advertisements.

This invention works together with documents 10, whereby such documents 10 may be found in a document base 10, also referred as a database 10, where the documents 10 are stored. An example of a document base 10 is a file system. However, a document database 10 may also be active, for instance, the database/document database 10 can be a web server or multiple web servers, such as the Internet. In doing so, the term database 10 refers to several systems or even to systems connected via computer networks. Therefore, the term document 10 is a collective term for all possible outputs of a database 10 or even for a summary of data generated by a user. A document 10 may be dynamically generated from a database, which is why a database is considered as a source or combination of sources in this invention, by means of which the data can be requested, written and/or modified. Thus, document 10 is a logical unit, a partition, component and/or subdivision and therefore applies to parts of document 10. Such parts of document 10 are also called as document fragments within the scope of this invention, which implies that such a document fragment is a part of the larger logical unit. Therefore, the models of this invention use structure information of the database 10 to improve access and analysis of the database 10 and/or to boost it. The following data and associated system or systems may solely be used as database 10 and as document 10: hypertext documents, Word documents, E-Mails, web server, program code, version control systems, API retrievals or feedback values, Sub-version, CVS, Application Server, SAP system, Data Warehouses, text documents, images, audio files, social networks, videos, Geodata, component models, virtual machines, Issue Tracking Systems, test cases, models, domain-specific languages, OpenOffice documents, blogs, Twitter, social networks, mobile devices such as cell phones, Peer-to-peer networking, input devices, file systems, databases, search engines, servers, routers, machines, sensors, test systems, debuggers, people and/or cars. If this invention is used in a computer network, then this network and its participants assume the role of the database 10, for example, as the internet network in the Internet, Peer-to-Peer Networks, web servers, web sites, clients, mobile clients (such as, mobile phones, notebooks, PDAs, etc.) and others. A website is distinguished as document 10, if it is accessible via the Internet and may include various contents that occur there, for instance, it may contain Hyperlinks for Hypertext documents, videos, pictures and other documents 10. The term Website may also stand for several documents 10, such as all or some pages under a particular domain. Thus, the term website is also a collective term for what is commonly called as website or webpage, i.e. a collective term for the entire web presence, such as, appearance of a company, an organization, an individual, an association, a pressure group, or for a specific purpose like, sales, trading, information, discussion, exchange, fun, search, intervention, etc. Such a website can be transmitted via different protocols like TCP/IP, HTTP, HTTPS, FTP, POP3, SMTP and other protocols that are used for communication in computer networks.

The term Tag often appears in this document. A Tag can be regarded as a synonym for the term Marking which is usually generated by the user. Thereby, the term “tagging” implies the process of marking and can ultimately involve marking “Tag”.

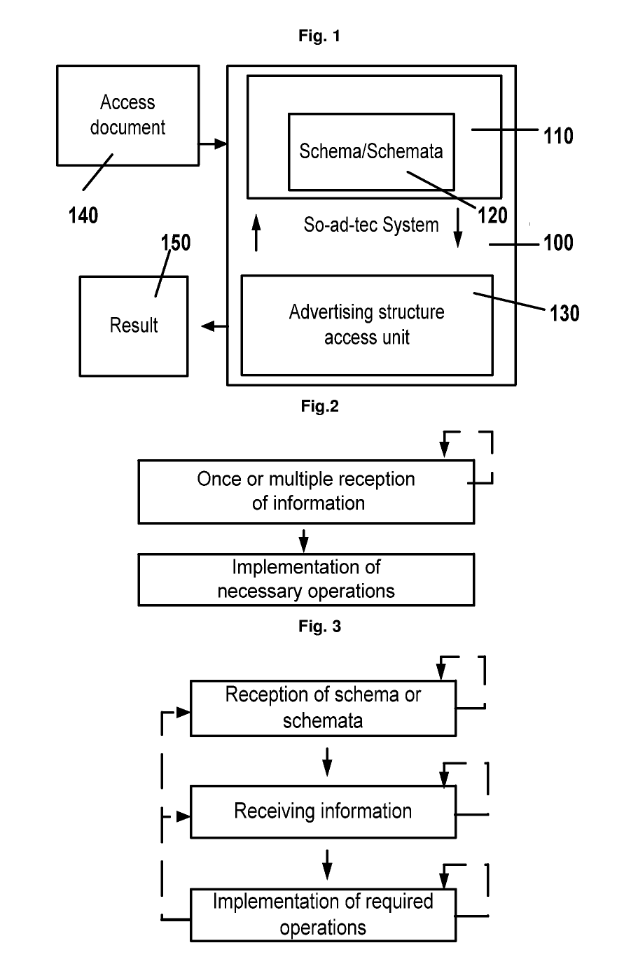

FIG. 1 illustrates a So-ad-tec system 100 according to this invention. A So-ad-tec system 100 receives one or several access documents 140 from an input unit—not shown, wherein such receipt may also imply even a reading of document 10 from a database 10. Or the access document 140 may include a reference to document 10 in a database 10, which will be eventually used as access document 140. The Access document 140 may be created by both, human user as well as a machine. A So-ad-tec system 100 features resources for processing an access document 140, such as an advertisement structure access unit 130 (also known as access unit in this document). This utilizes the contents of access document 140 to execute necessary operations and generate one or several results 150. Such operations may be, for instance, e.g. compiling the result 150, or while writing/modification procedure in one or more schemata 120 or other resources.

In doing so, a So-ad-tec 100, contains resources such as a schema 120 and/or a storage unit 110, wherein or by means of which, advertisement or other data can be structured. These resources can be used while executing operations. For instance, one or more schemata 120 can be extended with an access, by adding new elements or one or more schemata 120 may be used in combination with the contents of access documents 140 to respond a query.

In classic sense, access Document 140 and result 150 must not be document 10. The previous definition applies for an access document 140. For instance, an access document 140 and result 150 may also be the retrieval of API functions. This may also be other techniques that are used while accessing computer-implemented inventions. In result, an access document 140 and/or result 150 represents any information for controlling a So-ad-tec system 100 or other systems presented in this document 10.

In an alternative model, a So-ad-tec system 100 must not be made available on one or several fixed installed schemata 120. Rather, such schemata 120 may be specified as content or add-on in one or more access documents 140. Thereby, a So-ad-tec system 100 can also be implemented by a method as illustrated in FIG. 2. In doing so, the operations that shall be executed after the reception, may also include the storage of one or more received schemata 120 for using at least one more access. This is illustrated in FIG. 3. In the process, this method or individual steps can be carried out several times and/or you can even go back to the previous step.

All other variants of systems presented here can be implemented in the methods or extensions of the previously illustrated methods.

Basically, a So-ad-tec system 100 offers the functions for different applications. It can thus perform analysis on how often certain advertisement has been retrieved or clicked. Or it can be used as a search engine for advertising or advertising of certain components like display, especially for suitable context. Furthermore, it can be used to link contents of documents 10 with advertisements, for instance, products. For example, a suggestion list is presented to the user for marking products in the images by Tags or Tags could be assigned to products. Moreover, advertisement can be structured by Schemata 120, for instance. Another application is the dynamic generation of suitable advertisements, like in the form of advertisements, which can be personalized for the user. The major part of this invention can be further assigned to content other than advertising and can therefore be used in other areas, particularly while setting in the field of knowledge structuring and access to knowledge. Moreover, it is possible to use the system in other fields such as in medicine or psychology. This may assist in analyzing or identifying the knowledge connections/knowledge networks/adventure networks of people for enabling better treatment of traumatized patients. Thereby the individual skills of a So-ad-tec system 100 can be implemented as an independent technical device or may be combined into a single device. A So-ad-tec system 100 may also be used to evaluate the relevance of advertisement to access documents 140.

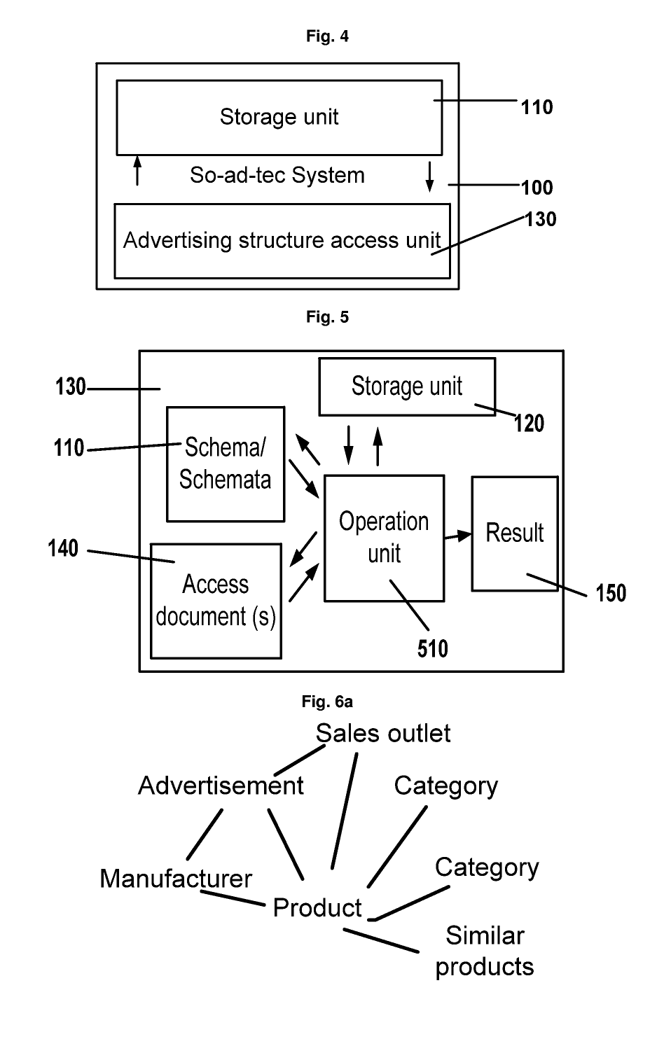

It is specially recommended to store schema 120 in a So-ad-tec system 100 within a storage unit 110 so that this system may receive or more schemata 120 or modify and add even delete the existing. An example of this is illustrated by the combination of FIG. 4 and FIG. 3 or FIG. 2.

Further data can be stored in the storage unit 110. This may include, advertisement, advertising data containing which advertisement was retrieved or/and specified in results 150. In addition, even the responses of the user for advertisement will be saved. Thus, the storage unit 110 must not just be regarded as a storage unit 110 of a computer; rather this storage unit 110 and the schema 120 can be distributed over a computer network, like a database cluster, for instance. Usually, all options are possible here for a database.

Furthermore, a So-ad-tec system 100 have resources that directly allow clients 920 who directly operate one or more schemata 120 via access documents 140, as if they were a file on the client. However it is specially preferred that a So-ad-tec system 100 has other resources, which simplify the adding, deleting or editing of information to schemata 120.

It is to be noted that a schema 120 need not necessarily be present in the infrastructure; rather it may exist on systems of the advertisers. In this case, a So-ad-tec system 100 assumes a role of integrating various schemata 120, which may be present in systems.

A So-ad-tec system 100 may also determine the relevance of advertisements with respect to an access document 140 and a schema 120. It could also generate the lists of advertisements that are sorted by relevance.

A So-ad-tec system 100 may also be implemented by special supporting hardware. For instance, Fuzzy Chips may be used for probability operations or GPUs to accelerate parallel processing.

It is specially recommended that a So-ad-tec system 100 or other systems introduced in this document be accessible via the Internet. In doing so, these interfaces enable particularly easy access to functions. For instance, REST, http, Web Services, SOAP and other common technologies as they are known from the best available technology.

The specially preferred clients, who may be used for all mentioned systems, especially for the delivery of advertising are known as clients 920 of the computer network from the best available technology. For instance, web server, automotive vehicles, Smartphones, regular cellular phones, VoIP devices, TV and other domestic appliances such as a refrigerator or microwave, and others with internet connection, Notebooks, computer, web server, websites, social networks and other known techniques or technologies.

The advertisement or/and the associated elements may be structured in a schema 120. For instance, by means of relations, categories, taxonomies, predicates and or other means that make it possible to be useful for structuring in any manner or be useful for detecting suitable advertisement. For example, one such schema 120 could be an XML file, a semantic network, ontology, like RDF and OWL are XML Topic Maps or a learning network. All the technologies can be combined or replaced by equally powerful options. In doing so, the schema 120 may be hierarchical to classify categories or other objects, such as advertisements or products.

Then these and other objects could be classified into one or several monohierarchies, Polyhierarchies or heterarchies or mixed form. Here, in terms of taxonomies, it is important to note that objects in a taxonomy, which are usually present in a monohierarchical structure, may also exist in other relations, parts or taxonomies. This invention enables does not requires only one specified schema 120 to be used mandatorily, rather they can be several. If predicates are used to express relations of objects in Schema 120, then these may include inheritance relations, authority relations, partitive relations, synonymy, antonym, causation, property relations or other relations that aid in expressing relationships between objects (elements of schema 120). In addition to this, other known resources may also be used in such schemata 120.

Another alternative for implementing this schema 120 is to directly execute it by the program code. In doing so, the entire schema construct of this invention can be directly implemented by program or similar constructs in software development. This is particularly advantageous to increase the speed of this system.

Here, not only objects are assigned to the categories by one or more schemata 120, rather it can be used much more than simply classifying the objects. It may be used for new experiences, such as in the is form of access documents 140 like appearance of a product and to modify, extend or improve one or several schemata 120. For instance, this can be done by modifying the properties of categories.

Another option is drawing inferences, which can be used in combination with a schema 120. This can be done by specifying in schema 120 or by other means, such as an Inference engine and Inference data. The advertisements can be further specified by drawing inferences. Along with other resources, together with other data from one or several access documents 140, this can be used to determine advertising or data on it. Other techniques such as deductive or inductive conclusions can be used in combination with a schema 120. It is also possible that resources are stored, which specify the similar objects in schema 120.

It is also possible to store probabilities in one or more schemata 120. For instance, there may be a product from different manufacturers. This product can be assigned both the manufacturers in schema 120. In the process, it is also possible to store the market share in the regions. For instance, when a product has been identified in document 10, then this probability may be included in determining the manufacturer. Another example for the using probabilities is the categorization of objects into schema 120. Often, the objects are assigned to different categories and ranks. For example, a Smartphone is assigned to a mobile phone and organizer. In the process, the affiliation determined by the measure could be used as probability. Thereby, it is also possible to store other probabilities on use or user groups in schema 120 because different user groups may perceive different categories. It is particularly preferred that such probability schema should not be rigid, but may be adaptable on the basis of feedback mechanisms.

The Bayesian network can be used in combination with or in a schema 120. Thereby, a So-ad-tec system 100 has specially optimized resources.

The knowledge from psychology on formation of category and knowledge acquisition is applied in schema 120 so that this schema 120 and its categories correspond with those of human perception and the categories are not inflexibly demarcated from each other.

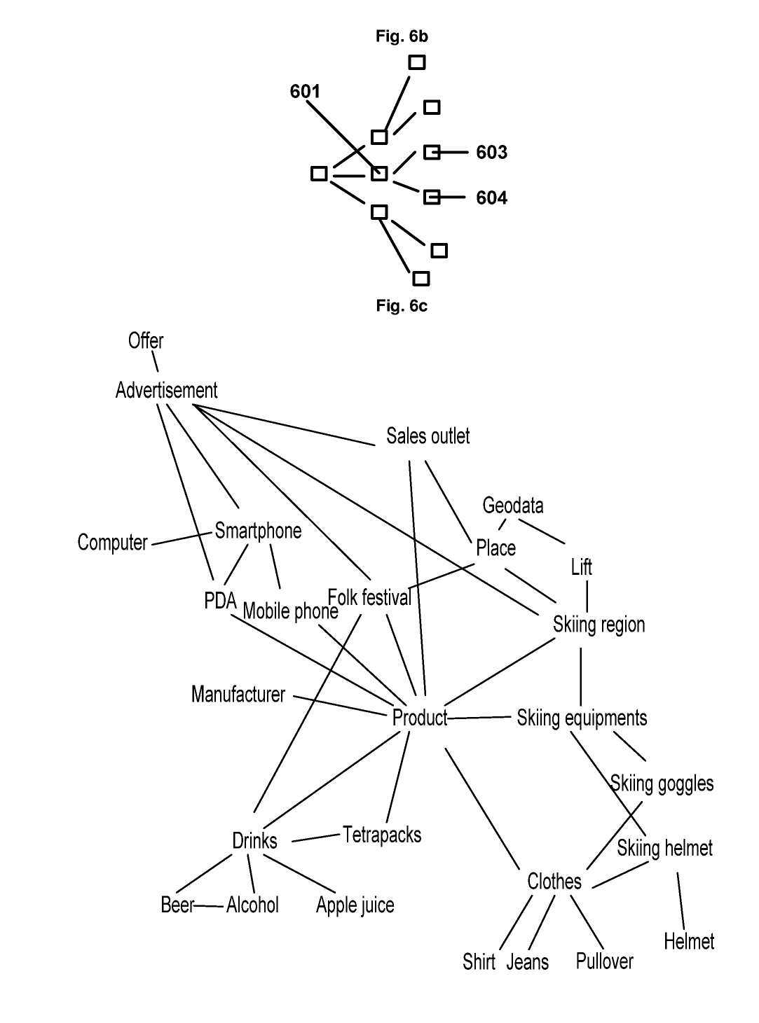

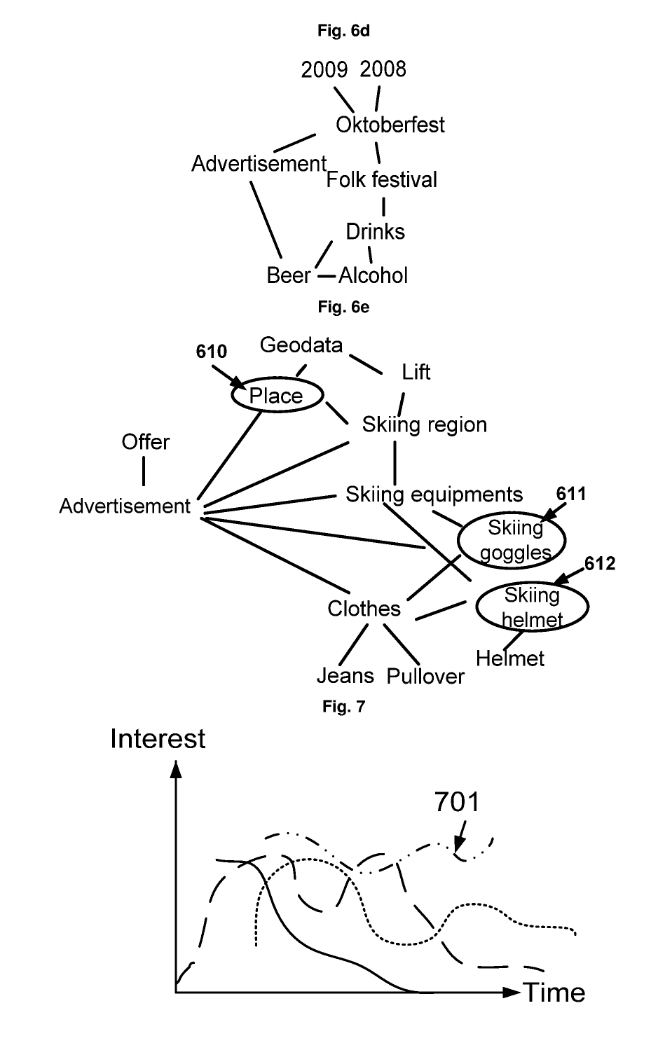

An example of schema 120 is illustrated in FIG. 6a. This schema 120 assigns products, manufacturers and retail outlets. Products are assigned to categories and related products. It is not shown that these related products and categories can also be hierarchically arranged. It would also be possible to assign categories to retail outlets and advertisements. The schema 120, which is illustrated, should therefore represent much more than the basic idea of such schema 120, similar to a concrete schema 120. All the figures of schemata 120 regarding further process should be added so that only a few links are shown to improve clarity.

FIG. 6b illustrates an example of an abstract schema 120. The individual points shall there by represent nodes. It may represent 603 and 604 sub-categories or to an object of 601 assigned to a category, for instance. In the process, even the affiliation of 603 and 604 to 601 may differ greatly. For example, by percentage affiliation.

It is also possible that FIG. 6b may represent characteristics. For instance, 601 is a characteristic of various objects and 603 and 604 are assigned to this characteristic.

An example of schema 120 is illustrated in FIG. 6c Here, however, the relationships were not explicitly determined to be accurate by mentioned predicates, but this was possible. The products, categories, other objects and relationships between them are illustrated in an example as objects in schema 120. It is to be noted that all possible and logical connections were not shown in this schema to ensure clarity. It has to be observed that clothes have a relation to a product. Furthermore, a pullover is related to clothes, for example. This could mean that clothes inherit the properties of products and/or represent a categorization.

It must be observed that the ski goggles belong to clothes as well as ski equipments. Here, for example, it could not be clearly defined how much it is affiliated to the clothes and to the ski equipment. Precisely the same is seen in mobile phones, PDA, smartphones and computers. A Smartphone is a mixture. In the process, the schema 120 can still be extended and which personal group contains which affiliation perception could be received from affiliation figures. For example, a PDA developer would classify a Smartphone as PDA, while a mobile technician would consider it as mobile phone and computer scientist will classify it as a computer. The connection between drinks and tetra packs is also interesting. This link can be interpreted as “are often” with the predicate. Thus, the conclusions could be defined, along with the probabilities and thereby unclear, up to 80%, a drink is in a tetra pack, for instance. Similar is the example of relationship between the ski region and the clothes found there, wherein there is an indirect link via ski equipment. In this case, a direct link would be possible. This indirect or direct relation could mean that the products used in a ski region are associated with very high probability to the ski equipment. Here, it is possible to describe the relation to ski equipment again by a predicate since ski regions are also open in the summer. For example, winter. The winter actually represents a node as per the previous understanding. Therefore this implies that this schema 120 may have “borders” that are again described by the borders and thus the position of nodes is assumed and vice versa.

A sample advertisement connected with various nodes is illustrated in FIG. 6c. This illustrates that an advertisement may refer to specific nodes. Thereby, it is also possible to define different nodes addressed by the access document 140. This relation could be determined by the advertiser, rather automatically by the specialized resources for it. For instance, from product information and statistical surveys. Since nodes and borders can be analogously treated, the advertisement may refer to the borders. Furthermore, an advertisement may also has one or more rules or computer programs, like how an advertisement is dynamically generated from different accounts. This can be used for dynamic generation of advertisement suitable to the context or the user. Such rules or computer programs may also contain fixed defined contents such as texts, videos, audios, images, which enables automatic adding or substituting information obtained from a variety of content by nodes or content in access document 140 or/and by rules or computer programs. It goes without saying that it may also include other external or internal information.

It is to be noted that an advertisement may also be allocated to various categories, products or other objects with quantifier/strength of affiliation. It can be specified in further data that the advertisement is assigned to several objects. Thereby, even logical links or complex assignment rules may also be specified.

An example that simplifies this is illustrated in FIG. 6d. In doing so, an advertisement of Oktoberfest and beer is assigned. This could be an advertisement for a certain Oktoberfest beer, for instance. In this case, it is also possible to associate the advertisement with only specific years of the Oktoberfest.

In terms of Schema 120, it is important that the advertisement must not be directly stored in Schema 120, rather it may deal with references to schema 120 for the advertisement. This is also possible in the reverse variant. Usually, the structure of this schema 120 does not necessarily directly corresponds with the logical representation, rather such schema 120 puts forth a plan of implementation to use other resources for its implementation. For instance, to optimize the operations and accesses that use schema 120.

The advertising structure access unit 130 can be observed in FIG. 5. This is available via an operation unit 510. The content of one or several access document 140 is combined with the data of one or more schemata 120 by this unit or other means such as the storage unit 110. The conclusions are formed thereof or the data is written and/or modified.

As it can be observed, such advertising structure access unit 130 may use or create additional data. For instance, this data could be the data from storage unit 110, as described above. Information about past accesses or operations can be filed in this data. The rule and/or program or references to the same can be found in these data, which may be used for accessing. Such rules or programs can be used to determine which advertisement are best suitable to access documents 140 and/or to schema 120 and to generate result 150 with the advertisements.

In contrast to the best available technology, it is thereby possible to use the context not only for a website to determine advertising, but also includes websites that have been visited while determining advertisement. In doing so, special means are used for this application.

Thereby topics, classifications, categories, and other objects found in a document 10 can be determined. Usually all resources that appear in this document 10 can be used. Thereby, it can be determined which of these things particularly appear. An interest evaluation can be filed for every object in the storage unit 110. The more often an element appears, the more it seems to interest the user. If this element does not appears any longer, then the interest of the user drops. This can be used on a social network website, for instance. Thus, the duration of interest region crystallizes itself out, due to which the user browses the social networking website. The interest assessment can be used to determine particularly suitable advertisement.

This may also be used to adjust one or several schemata and create new links in schemata. Usually, this is used beyond the application of advertisement and can be used as an independent device to generate knowledge bases, for instance. Moreover, the determination of user interest is not only advertisement but it can also be used for other purposes.

An example is illustrated in FIG. 7. In doing so, different types of routes, topics, categories or other existing objects. Based on time, they gain or lose interest. But there may be objects that are held constant at a high level, for instance 701. This may indicate that this is a key issue for the user. Moreover, how objects and interests are related to each other may be used to create or improve the analysis schema 120.

US 2008/0313175 A1 provides a method by which is actually intended for task-centered work. This can be used to determine an interest context similar to a task context, which is advertised by the advertisement. Such interest context can be determined by the actions of the user, in which case one or more schemata may also be used. All calculations, including implementations of the model (http://tasktop.com, http://www.eclipse.org/mylyn) for interest evaluation can now be utilized in relation to advertising and other elements of this invention. Even on ordinary documents 10. The summary of the system is as described below:

storing of data in at least one context of interest, based on the actions of at least one user;

wherein the context of interest is used to draw conclusions about the interests of at least one user

The method or system receives the content several times and the interest of the user is derived and it can be applied to search engines. For instance, if a user searches a term and does not receives a satisfactory result. Then he will modify the search parameters or terms. The primary interest or the interests of the user can be identified on the basis of terms, topics, categories or other elements that appear again and again. This can be used to determine particularly suitable advertisements thereof or even to present better search terms and/or results, which are actually sought by the user.

It is specially recommended for use with a hyperadapter (EP09180953), wherein the primary interest areas could be the dimensions, searches by the user, for example. which the user searches may be. The summary of the system is as described below:

The categorization of the user of relevant search results or advertisement, based on the recording of user input;

wherein this system or method has additional means which enables determining accurate interests of the user by means of user inputs

In doing so, the categorization of search results can be combined with assistance, recommended solutions or solution functions. Thus, this search engine can use all other resources mentioned in this document, 10 and are known from the best available technology.

It is to be noted that the above description was based on individual user. But the method and system can also be applied to user groups of users and have specialized resources for it. For example, the data from other users in the past can be used to determine whether their interests were distributed similarly for quicker identification of the primary interests of an active user. The context of content can also be used together by multiple users or may be made available.

A So-ad-tec system 100 may receive further rules or programs by access documents 140 or references therein for future use. Here, the So-ad-tec system 100 has resources which allow editing, modification or updating these rules or programs. This can be done by a configuration file in which the rule or programs to be used are specified.

Since such rules or programs may also be transmitted via access documents 140, an alternative or additional execution of data is not locally available; rather it is exported by result 150.

An example of executing an access is categorizing the advertisement on the basis of content in the access document 140, in combination with schema, as illustrated in FIG. 6e. Here, a sample schema 120 is illustrated which depicts the various nodes and edges assigned in the advertisement. These advertisements are mentioned as advertisement in the figure. The nodes with enclosed with circles represent nodes identified on the basis of information in one or more access documents 140 or by data. Thus, for example, the ski equipment node and clothing were determined to which the ski goggles and ski helmet nodes are associated. In terms of location, it is to be considered that this is also indirectly linked with ski equipment by ski region. A ranking of nodes can be defined thereof, which may be used to determine which advertisements suit best.

It has to be noted that in FIG. 6e all nodes appear to be equally responsive. However, it is possible that these are addressed to different extents.

A schema in So-ad-tec system 100 can also be hierarchic, as illustrated in FIG. 6c. A major advantage of schema 120 is that advertisement can now be assigned to categories also and not to just words. This and other features of Schema 120 allow target-specific detection of advertisement for data specified in access document 140.

The advertisements may be assigned to the nodes in FIG. 6b. For instance, the nodes 603 and 604 and 602 are addressed by the access document 140. By Scheme 120, it is now possible to identify node 601 indirectly affected “child nodes”. Thus, this information can be used to determine suitable advertisement. This makes it possible to observe the advertisements while generating results 150 that are linked with nodes 601.

For instance, The data addressed in schema by the access document 140 may also be the user data or context data of a document 10 and document 10 must be embedded in the advertisement. For instance, the context data could also be tags, or just words as well as other types of documents 10, like image section.

Thus, it is possible to associate more words for a category. This often eliminates a relevance rating, because a suitable category is directly detected.

The lists of advertisements can also be generated by a So-ad-tec system 100, which can be sorted by relevance. An example of the advertisement list can be the advertisements detected on the basis of schemas here may be ads that have been uncovered in the schema and the contents of the access document 140. An example of relevance sorting can be a sorting by order or even by the best suitable advertisement or a combination of both. Another example can be a list of advertisements situated on the linking nodes and edges of the schema. Thereby the “intensity of distance” or a node can be used for generating lists of advertisement by means of schema.

As explained previously, other means can be used. For example, probability or development levels specified in the schema or in the access document 140 or can be calculated from the contents therein. For instance, various nodes are evaluated with various degrees. This location could be less important, such as ski goggles or ski helmet. Or the probability of an edge, site to which a ski region belongs can be specified. With this consideration, it is explained that such probabilities or “strength characteristics” must not be allotted only to one node or an individual edge but also on several. This can be specified using probability rules: If nodes A and B are specified as activated by an access document 140, it follows that node C belongs to 50 and D to 30% probability respectively.

The content may be present in access document 140 or the storage unit 110, which are directly or indirectly related to the user and/or the context in which the advertisement is used. For instance, in FIG. 6e, ski goggles 611 and ski helmet 612 are marked on an image by a tag, which is viewed by a user. The native place (location 610) or the residence, for instance GPS, IP localization serves as the content of user on the basis of localization mechanism. The location could then be weighted more heavily, because the user is located near a ski region. Thereupon, as described above, the ski equipment is not recommended as the best suitable match rather the ski area is recommended and especially the ski area in the vicinity of the user.

It is also possible to combine and compare the current user data with the user master data to use the current location and the native place as well as this assessed information, especially on which advertisement is finally suitable.

Calculation rule or algorithms can also be used to calculate the intensity. For example, the vector of the context is multiplied with the vector of the user to boost the individual dimensions in context.

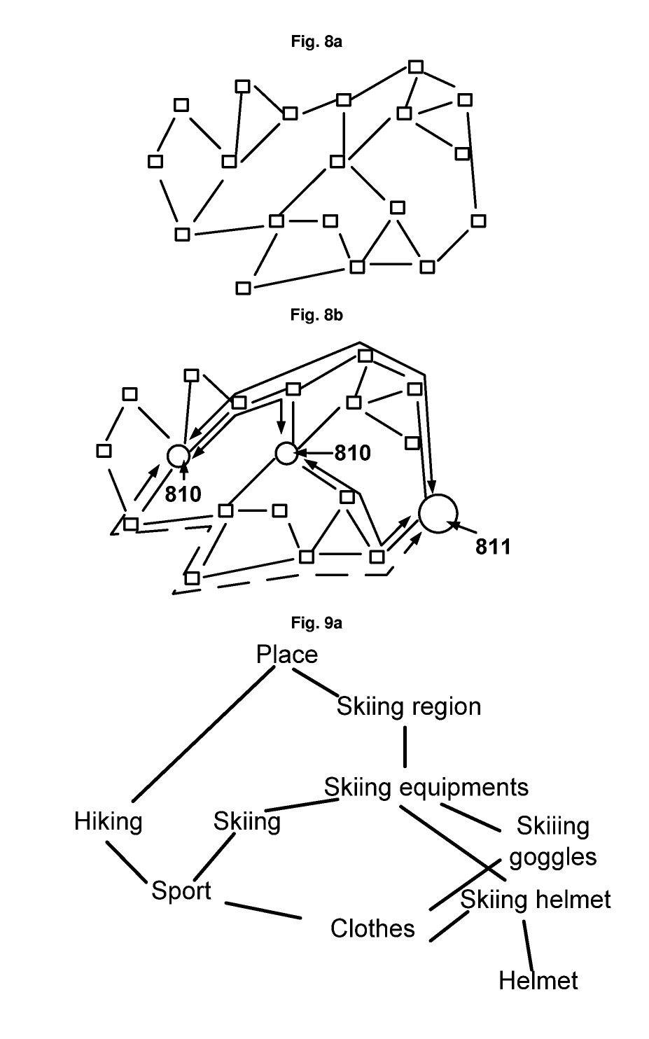

Usually, this schema 120 is considered as a graph. Thereby, the links in a schema are compared with the problems in other fields. This enables utilization of algorithms from other fields, such as in complex problems. The application of these algorithms can be used detect the suitable advertisements, gaining further information or for restructuring the graph. A graph containing schema 120 and sample nodes (circles 810, 811 for more responsive/accurate or quantifier) which must be addressed are depicted in FIG. 8a. The links between the addressed nodes are indicated by arrows. It is to be noted that a single edge can be pointed by several arrows at the same time. In addition, each edge may have one or more quantifiers, such as in the form of a path length or usage frequency. The edge itself may have other properties. As explained above, the edges may also be associated with edges, wherein the edges and nodes are termed equivalent.

The dashed arrow indicates that there might be alternative links or that the links may be directly evaluated from all nodes to “strong” nodes.

The algorithms from Swarm Intelligence or other observations from animal kingdom are used in a So-ad-tec system 100. For example, with Ant Colony Optimization (ACO, http://www.mboehmer.de/pdf/Schwarmintelligenz_Artikel.pdf), Particle swarm optimization (PSO, http://en.wikipedia.org/wiki/Particle_swarm_optimization).), Stochastic Diffusion Search (SDS, http://en.wikipedia.org/wiki/Stochastic_Diffusion_Search), Gravitational search algorithm (GSA, http://portal.acm.org/citation.cfm?id=1531036) or hybrid methods of the aforementioned.

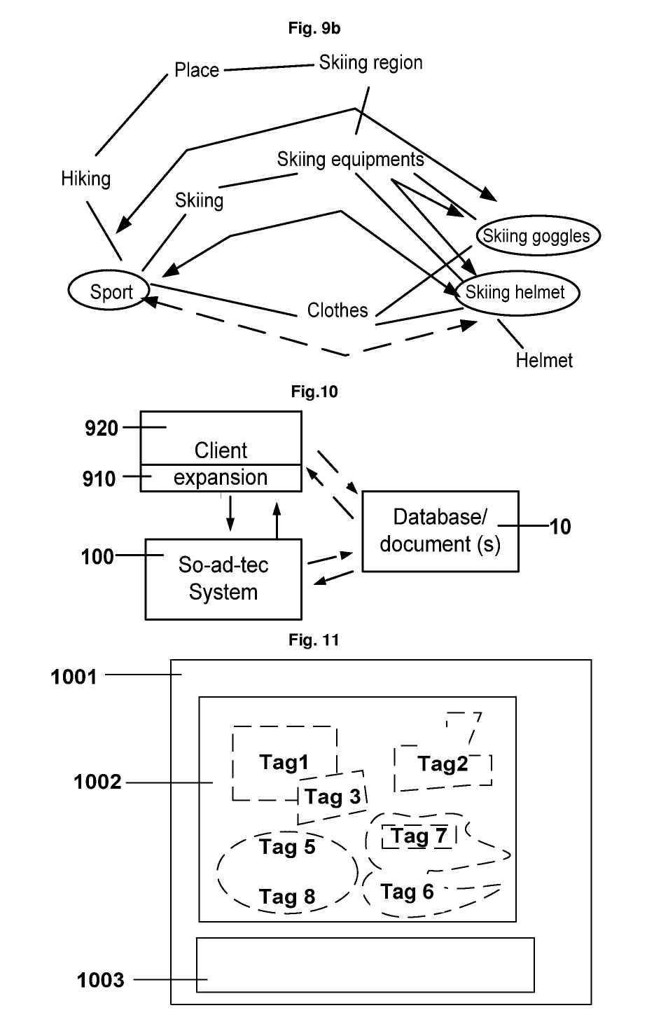

FIG. 8b illustrates an example of determining the links between nodes through the Ant Algorithm (ACO), or variations thereof to determine the links between activated nodes. Thereby, it could be determined which nodes and edges are visit most often while searching links. In doing so, the “pheromone” in ACO could be filed on the edges and nodes. As a result, the information from previous link searches can be utilized with every link search. The general schema is illustrated in FIG. 8a as well as 8b and FIGS. 9a and 9b demonstrate with a more concrete example.

It is specially recommended to further optimize the ACO for this application. An example of this optimization could be to reduce the distances of frequently visited edges and to develop the rarely used edges slowly and/or up to a level. This system would enable the automatic structuring of schemata 120 by utilization. Thereby, the same topics/objects/classifications or other schema elements may appear together which would result in the schema structure 120. This idea and optimization does not only apply to the advertisement, rather generally for structuring of relationships in one or more knowledge bases.

As mentioned previously, another option for improvement could be the result 150, which is evaluated on the basis of such algorithms and execute the actions corresponding to it, which allow adjustment to the algorithm or its parameters. A simple example of an assessment could be the assessment of advertisement determined on the basis of links. For example, which is displayed to a user. If the user clicks on the advertisement, then the link appears to be good and can be interpreted as a positive assessment.

Another option or addition is to use GSA. In doing so, the rules of gravitation are used by this algorithm. For instance, it is thereby possible to describe the relationships in the schema by gravity. Thus, such a schema can be compared with a star cluster, in which the individual stars move. Thereby, other methods of calculations from the field of astrophysics are applied to such a schema. Other complex applications, such as moving planet models are also possible here.

Especially optimized hardware or engine can be used in a So-ad-tec system 100. For example, physics engines and accelerators, for instance to calculate the gravitational or graphic processors at the GSA to execute faster parallel computations faster, or it can be used for fuzzy operations of DSP chips.

Thereby, an access is not restricted to the retrieval of information and the known methods of analysis are used on the basis of schemas, together with other data, for instance. Such analyses may be executed with Data Mining Algorithms such as A*. Another example is to use the data from access documents 140 or data from the storage unit 110 in combination with one or several schemata. Thus, it can be identified which products have been purchased by the friends of the user, who is also linked with the product in the schema 120 that are similar to the products in which the user is interested. For example, a user is interested in ski helmets and his friends are holidaying in a ski region. Then this information could be used for determining the suitable advertisement for the user.

In turn, this analysis can also be used to add more information to one or more schemata 120. For instance, new nodes and edges are created and deleted thereof, or the existing ones are modified.

Other findings from the probability theory are also used in a So-ad-tec system 100, for example, the cluster analysis. These can be used to divide schemata or other data into clusters. Or the user can be classified into user cluster on the basis of their interests.

The links may also be structured differently in schema on the basis of different user clusters. Thus, the Information on user cluster can be stored in the schema or the storage unit 110. This could be used for different assessment of paths/edges of different users, depending on their cluster membership. The main idea behind it is that there will always be a user, who closely resembles others, at least partially. These groups and thereby generated knowledge can be used with at least one additional operation by means of cluster analysis.

Another form of analysis is the application of a PSO Algorithm. This may be used on user data in combination with one or several schemata and other data. For example, the user data can also include tags. Hereby, persons or products can be marked on images by tags. Thus, it can be examined, which user is a part of a swarm. For example, on the basis of tagged products that can be viewed on images with users. The association of users to certain tags on images can be understood as particle movements. An analysis can be done on this or similar findings to determine which users are members of a swarm initially become active with which member products. It is also possible to consider categories or context of products by schema. The figure is illustrated as follows: the schema and other data in the So-ad-tec system 100 may represent the country over which a swarm of birds fly. The individual birds represent the users. This moves into a multidimensional space, containing various coordinates, over a period of time. These coordinates are defined by the schema and other data. Now, it is possible that the individual bird/user may accept certain coordinates. For example, by associating with a certain location, such as a ski region. Another user may come to these coordinates after a certain time. Or users “fly around” certain points in a scheme and others follow.

Other analyses can also be applied on the basis of this view. For instance, a large swarm consists of several small swarms. Or even to generate forecasts.

A So-ad-tec system 100 can be used for generating advertisement specially customized for the user. Here, one or several schemata, user data as well as content data can be used, for instance. As the advertisements are specially customized for the user, it is also possible to generate advertisements based on schemas, suited to the context.

The analyses in So-ad-tec system 100 can also be used to detect the opinion influencer or to determine which users are good test subjects for accepting advertisement. This may be done by a previously mentioned analysis in comparison with the PSO algorithm. An example could be the consideration of advertisement by the user according to his choice, part of the map and the bird data.

In addition to this, a So-ad-tec system 100 can be used to directly write into the schema. For instance, new nodes are directly added or the existing ones are modified. Another example of writing the data is the addition of data to the storage unit is 110. The modification as well as deleting the existing data in the schema or/and the memory unit 110 is often included under writing.

It is specially recommended that a So-ad-tec system 100 contains resources which support the advertisers which adding advertisements. For instance, a So-ad-tec system 100 may have an analysis unit, which receives document 10 by the advertisers or other sources as well as their advertisement, based on the analysis and structures/adds them in one or several schemata 120. Other sources or source systems are used in this analysis. An example of structuring could be a classification into categories, in which the advertisements must appear or even the creation of new nodes or edges in the schema 120. Ideally, product data sheets or even information generated from the users are used in this process. Similar categories can also be detected on the basis of product data sheets, for instance. It is also possible to use the analysis of images or other media documents to support the advertiser by arranging his advertisements in the best possible way. Such support may also be provided semi-automatically, by interactions with the advertiser, for instance. The advertisers can directly receive access to at least one schema. The advertisers can change the writing operations and add things as well as offers.

Furthermore, as described above, other functions such as other program code or inference rules on writing operation can be added to a So-as-tech system 100.

It is particularly preferred that this system contains other resources to enable determining how often and advertisement is viewed or perceived positively. This can be used for billing purposes by other resources. Systems executing the management of advertising accounts and tracking campaigns are from the best available technology and can be used in combination with a So-ad-tec system 100.

Because of its ability, the So-ad-tec system 100 can be too used to embed advertisements such as websites, videos or photos in/to documents 10 at the Internet. Thereby, all options which are used in other technologies on the Internet and on mobile phones/Smartphone can also be used.

For instance, this could be the lists of advertisement. It may include the text, images, videos, or parts of it stored by hyperlinks, which associate with the advertisement or refer directly. Advertisements can be sorted by relevance.

If advertisement is displayed to the users, then it is also possible to display the information associated/referred with the advertisement, such as preview image of the target website or images in the hypertext documents. The mouse over effects can be used for it, for instance.

It can be transmitted to the So-ad-tec system 100 by clicking/selecting the advertisement. This can also be used to enter information into schemata, or debit from the account of the advertiser for current offer.

It is furthermore possible that only entries are not made in the account of the advertiser, but these entries are done on the basis of other information, such as the operator of a website.

FIG. 10 illustrates various options of how advertisement can be displayed or delivered to a client/consumer 920. First of all, the client 920 may directly retrieve information from a database 10. The advertisement may have been already added here. Or the client 920 retrieves advertisement on the basis of an extension 910, such as through a plug-in, JavaScript, Silverlight, Flash or similar technologies. It is also possible to dynamically load the extension 910 in the client 920, such as by a computer network. For this purpose, there must be a reference to a script in document 10. The implementation of similar types with this system configuration is also of the best available technology and can be used at this point.

A So-ad-tec system 100 can be combined with other technologies, equipments or methods. For instance, with US 2008/0126226. In addition to the well known advertising options, it is also possible to integrate advertisement in images or videos that can also be selected by the user and is not just displayed. This can be done by using tagged areas and/or the addition of hyperlinks to this or even by using US 2008/0126226.

Another advantage of a So-ad-tec system 100 is that, unlike illustrated in US 2008/0126226, only advertisements may not be added, but also more suitable advertisement may be selected, which can then be finally embedded as per the method.

The feedback of the user can also be transmitted by displaying advertisement. For example, how long a user viewed the advertisement before he clicked on it or even the characteristics of his profile.

Another option would be to use the So-ad-tec system 100 in combination with a search engine. In doing so, the search term is considered as access documents 140. Another option is to use the first websites of the search result as an access document 140 and to determine and display the advertisement on the basis of their content.

Another option is to use So-ad-tec system 100 for determining suitable advertisement in videos, such as on YouTube. Furthermore, it is thereby possible to determine E-Mails for advertising. Another application is to use the advertisement based on short messages or video streams and live streams. It is particularly preferred here to use mobile clients 920, wherein the position of the life streams as well as context data and other data can be used to determine best advertising. A special optimization can be used in this case, in which the user data from several clients 920 are observed. The advertisement can also be customized on the basis of other characteristics of the client 920. By his resolution, for instance.

Another field of application is the social networking sites like Orkut, Studivz, Xing and Facebook. The context-related, user-oriented and structured advertisement can be initiated by this invention. It is also possible to advertise on the basis of tags through this invention.

It may be particularly advantageous to combine the use of user data, advertising use of combined user data, advertisement and context data can be particularly advantageous. The Exif data which specific the camera model with which an image is captured is stored in images. If the user views images and albums, the advertising images of the corresponding camera model are displayed with which the image was captured.

It is specially recommended that a So-ad-tec system 100 may also be used so that the users can tag products. In doing so, the user can associate document 10 or parts of it with data from a So-ad-tec system 100. For instance, an area can be marked on an image and be associated with a particular product or category.

Thus it is possible to “link” products in images. An example of this is depicted in FIG. 11. 1101 indicates document 10. This document contains an image 1102 or any other form of media, such as a video containing a number of tags. Furthermore, an example is illustrated by 1103 advertisements. With So-ad-tec system 100, it is now possible to select and display the advertisements 1103 on the basis of tags and other document contents. It is also possible to associate to display advertisements with the crossover of the area associated with tags, for instance: Tag 1-8. In FIG. 11, it can also be observed that tags can overlap, for instance tag 1 and tag 3. Or areas that are marked by multiple tags, such as tag 5 and tag 8. Another possibility is that, tags may also occur in it, as tag 7 and 6.

Therefore, FIG. 11 is not only regarded as an example of an image, but rather it may serve much more 1102 than an example of videos or video streaming or other types of documents 10, such as, embedded documents 10.

Another option is not shown, but they can also be tagged by other tags. Thereby, it is also possible to tag several tags at the same time. The relations may also be expressed. For example, a marked person “wears” the clothing of company XY. In this example, the person would be associated with a product and “wears” would serve as a predicate. But here it is to be noted that such associations are possible even without known predicates, for instance: Person “tag/relation” clothing, wherein the relationship is usually interpreted with the predicate “has property”.

As described above, each node can serve as a predicate. Examples of predicates could be: possesses, wears, likes, admires, purchased, charged, hears, eats, moves, part of, etc.

A So-ad-tec system 100 preferably has analyzers to identify products such as persons or items in images and/or video contents in documents 10.

Ideally, they can automatically generate tags and associate contents of documents 10 with nodes or edges in the schema and apparently generate references or other markings such as in the form of tags only internally. It is particularly recommended that these analyzers be used as hybrid system, together with tags that have been set by people. For instance, if a tag is not a precise framing of an object in an image or video, but is often too large, too small, or it has the wrong shape. Then, the actual desired product, which was roughly focused by a tag, can be determined on the basis of image analyzer. The analyzers may also be used to identify other things. For instance, if an image or other images in a photo album is too pale and the user is linked to it. Based on the user data that the hobby is skiing or snowboarding, and the recording date is in the winter, it is recognized that the picture or the whole album is created while skiing. Other things can be recognized on the basis of this or similar rules. This may also be happen again in interaction with the user. Then this could receive the probable content and then decides whether the analysis was correct. He can also receive the lists of suggestions to select, for instance, a list of skiing regions or the most suitable image content.

A So-ad-tec system 100 can also be available due to the moving objects in videos for “linking” and tagging. In the process, an object can be marked in a certain image/frame of a video, for example. Based on the analyses, it is possible to detect the specific object and to automatically follow with it with the next frame of the video. For example, the PSO algorithm can be used to track objects in video.

The results of analyzers or tags of users can be verified on the basis of a new CAPTCHA (http://de.wikipedia.org/wiki/CAPTCHA) system or method, hereinafter also known as SCAPTCHA System 1300, which may also be implemented independent of a Sun-ad-tec system 100. This system does not work as known from the best available technology for detecting words, rather to tag image areas or to check whether the contents of a tag correspond to its real meaning. A SCAPTCHA system features the following in a model:

An access decider for deciding over at least one decision of at least on access, based on the answer of at least one captcha;

whereupon the solution/answer of the captcha may be used to obtain information and such information is used for at least one other purpose.

For instance, this purpose can be: identification or/and classification or/and arranging themes by content of documents or parts of documents, classification or/and detecting objects, verification or/and evaluation of responses from other users, or captcha or their entities, education, evaluation and/or adjustment of categories or/and their relationships or/and one category system, creating modifying or/and adjusting at least one schema and/or its structure, determination of relationships or/and types of relationships, whereby such relationships could be described by complete sentences and/or other relationships or objects, classifying information in at least one schema or its parts, training of at least one detection mechanism or recognize or application of rules used by humans.

This can be executed as follows. An image section provided with a tag will be displayed with a question on which the image can be viewed. The user appears to be human as per the input of the user for the tag. Other rule can also be used here. For example, the terms for the images can also be determined by a system similar as in reCAPTCHA method or system, with the difference that it deals with image areas and not text. A schema 120 can also be used with the query, for instance to determine whether the term of the user is a sub-category or primary category of the tag terms.

Another option is marking the product on an image by a user. If the edge of the user is similar to the other users, then the user appears to be human. The new feature of this system that not words, but more complex structures such as media content can be used to distinguish between humans and machine and this content may also be classified as add-on.

As described above, one or several schemata 120 described in this document 10 can be used due to this differentiation. Another example is that a specific product such as an iPhone is shown to the user while he specifies one of the categories as a tag, for example: Smartphone or mobile phone. A human can be recognized by means of a schema. Furthermore, it is possible to use quantifiers in schema 120 by the input from users. During evaluation, it must be noted whether other users have the same answer as the present user. The frequency of response and other factors, such as IP address, can therefore be included while assessing whether a human is trying to solve the task.

The SCAPTCHA System 1300 is usually used for videos. Or by playing audio files. It is also possible to specify a brief text and prompt user to enter a tag for it. The results of which can be used to verify the results of analyzers or train the analyzers, for instance.

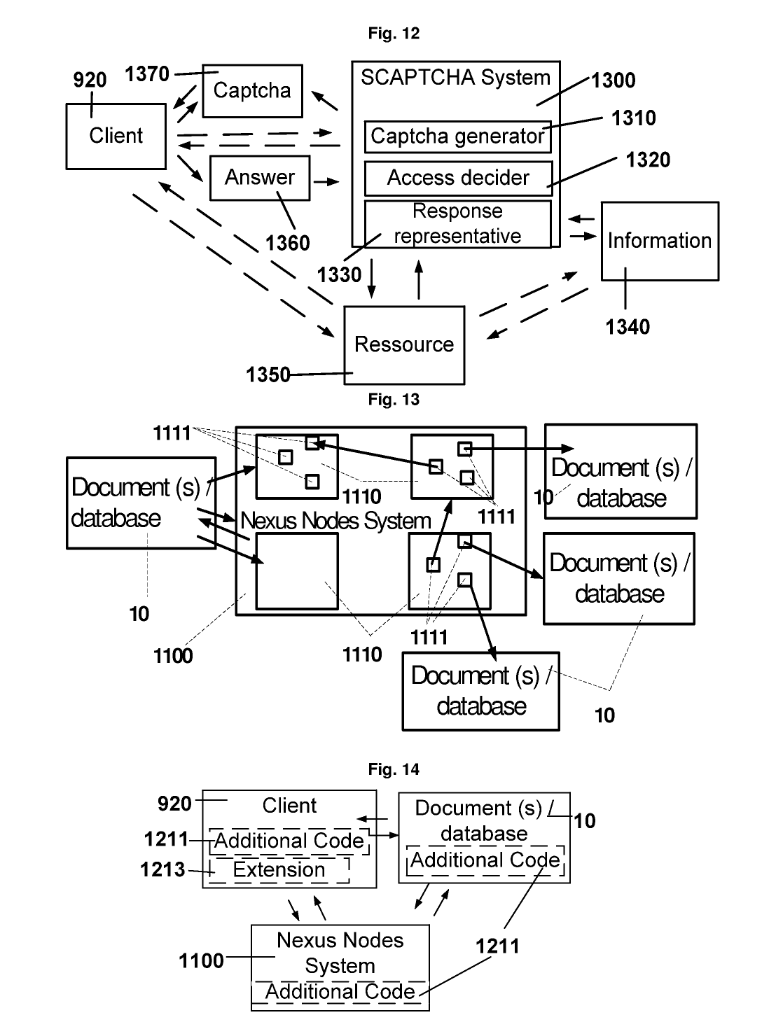

FIG. 12 illustrates a possible configuration for SCAPTCHA system 1300. This is created on the basis of details 1340 of a captcha 1370, to decide on an access. This information 1340 can also be resources 1350 or refer to them. For example, such resource 1350 and information relate to the current context so that the captcha 1370 suits it. The client 920 generates a response 1360 which is received by the SCAPTCHA system 1300. It includes resources, such as an access decider 1320 which determines, whether the resource 1350 may be accessed. In the process, it also has optional resources to use the response 1360 for other purposes rather than only for the access decision. For example, the response may be used for generating one or more new captchas 1370. This can also be used to determine the response 1360 of other captchas 1370. In addition to this, the other uses such as generating schema or object recognition, described in this document 10, can also be realized.

It is also possible to configure a schema based on the input of the user in SCAPTCHA system 1300. This has the advantage that the user may add new information on schema bit by bit and the schema is structured in a way most users perceive reality. But it is also possible that different schemata must be created for different users or user groups. Such a system can then use all the means suitable and/or important for the tasks mentioned in the document.

The nodes as well as edges can be quantified differently on the basis of tags and by one or more inputs of a SCAPTCHA system 1300. For instance as per the above mentioned tagging options, such as detecting the frequency of terms. Another option is to manage the tags appearing in the same document 10 as well as new edges and/or nodes in one or more schemata 120.

It is also possible to learn on the basis of tags. For example, which product may appear at which place. A product and a place or a type of place can be marked on an image. Therefore, it is known that a product may appear in this place. Thereby, we can know how often this Tag combination or an image provided with geodata and tags appears and this can is be entered in the schema details. An inference on the type of place can also be formed on the basis of geodata. Thus, the probability of a product appearing at a place of identified type or at certain geodata can be determined. This can also be used to customize analyzers, for instance. Or to suggest products while tagging. It is to be noted that geodata can be described as a radius to coordinate on Earth and thus a region can be selected.

A So-ad-tec system 100 may have an OCR unit. This can be used to edit digitized documents, such as in the form of PDFs, images, videos or documents. In the process, even more complex operations can be performed. For instance, a photo of a ski pass may lead to the retrieval of further information, such as a list of elevators.

For instance, this can be used to detect the clothing of the user which can be displayed on the basis of this advertisement. This may also be used to give recommendations for tags to the user while tagging his images based on the documents. Thus, the source of reference is automatically determined for the product.

The analyses are executed on the basis of tags. For product distribution in images, in combination with loading user data and schemata 120, for instance. How many friends of a user are skiing and whether this has been marked in the past on the skiing photo and to apply a suitable slogan to them such as: “Last week 5 of your friends were skiing, book Pitztal at very reasonable costs today.” The names of the friends who went skiing may also be mentioned. Of course, further analyses can be done. All examples on other regions can also be transmitted in the same way as skiing. For example, summer vacation, or even the use of products like: “Your friend X has a Dell laptop/iPhone . . . ”.

It is possible to classify/ “link” the entire clothes or personal products by means of the previously described features. This can be used to incorporate advertisements on the basis of products, which can be viewed in images or video. For this purpose, the details of location and purchase can be used or advertised. For example, it is possible if a jean worn by person was tagged: These jeans can be bought from a shop near the “court” for XX [symbol] . Or: The jeans were bought for XX [symbol] in XY shop. Hereby, generalized conclusions can be drawn, which simply refers to the manufacturer. The advertisement or mouse over effects is preferably presented by options of advertising methods mentioned in FIG. 11 and FIG. 10.

Another option is to use a So-ad-tec system 100 if the advertisement contains user-generated content. The products can be tagged on images, and then these images can be used to advertise products and embed them in/to other documents 10 as advertisement, for instance. This can be further optimized as user-centered, an advertisement is not displayed to the user, rather a friend of the user wearing/uses/considers/etc. this product. One can also view how an acquaintance wears a pullover or is enjoying in an advertised ski region. This makes advertising more authentic and attractive to the target person.

The models can be used in combination with a hyperadapter. On one hand, for analysis and on the other hand, the advertisement may be integrated in it. This can be done to associate the categories or other nodes of a So-ad-tec System 100 with the dimensions/classes in hyperadapter.

The major parts of invention are not yet known to the best available technology. Thus parts can be used not only for advertising, but also for other documents 10. Especially in the technology field of knowledge management and search on the Internet and in the field of artificial intelligence, for example. Several findings can be applied while structuring information. Such schema can be used in the invention, especially in conjunction with swarm intelligence to create equipments or methods which enable advantageous methods and equipments in these fields. The SCAPTCHA system 1300 and associated procedures as well as the to successive Nexus Node System 1100 can be used in these and fields to an advantage.

A Nexus Node System 1100 can be used in combination with a So-ad-tec 100 or SCAPTCHA 1300. The Nexus Node System 110 features the following in a model:

At least one node management unit, which allows management of at least one node 1110, which can be accessed through links in documents 10;

whereupon a node 1110 may refer to one or more targets and a node 1110 may have the function of standby for more resources.

This system can be used to enable bidirectional links or to set links from websites or other documents 10 on non-existing websites/documents 10. At present, the links may be set to “blank” only in Wikipedia. A Nexus Node system 1100 provides the same functions for all Websites/Documents 10. In this system it is possible that a link may refer to multiple destinations not only to one.

Such a system consists of Nexes 1110. These represent nodes 1110, which can be used as substitute for other resources, including those that will exist only in the future. Such nodes 1110 are accessible via a URL. “/” are used to specify hierarchies. These nodes can be a website for instance, which refer to other websites or Nexes 1110. It is also possible that other documents 10 may be found as contents “in” a node. Alternatively, they can also be stored in a nexus.

This may be realized as in FIG. 13. It refers a document 10, such as a website on the Nexus node system 1100. The target of these references is a Nexus 1110 or a target in a nexus, such as 1110. This can be technically implemented by a URL, for instance. The Nexus 1110 or its elements 1111 may in turn refer to one or several destinations. The information from the Nexus Node System 1100 can be directly integrated into the document 10, or can also be loaded onto the clients 920. This can be done by JavaScript or similar technology. Thus a user can may receive a choice of targets/links in Nexus 1110 while selecting by simply clicking on the link to Nexus 1110. It may also be that the targets that cease to have further targets in Nexus 1110 could not be clicked/selected. Another option is that the user clicks directly clicks/selects a reference in the document 10 and thereby is directed to a specially selected Nexus 1110, where it refers to the possible targets of the Nexus 1110, such as further Nexes 1110 and the elements in these or other documents 10 could be viewed.

The targets/references in/of a Nexus 1110 is to be stored, which can be done by the user himself or other technical equipment/processes, such as search engines and/or in combination with tags in documents

It can be observed from FIG. 14 that additional code 1211 or reference to code is stored in the document 10. As a result, additional code 1211 is loaded by the client 920, such as the previously described JavaScript code. This provides an option to the user for selected documents belonging to Nexes 1110 or to select Nexes in a document 10. With Nexes 1110, it can be detected which pages link to a particular site.

The extension 1213 of clients 920 can be done by loading additional code 1211 or by a Plug-In. This Plug-In can also be loaded with another additional code 1211.

A special form of application of one such Nexus Node System 1100 is that users may also actually enter the resources as nodes/nexes 1110. For example, a user can click photos of objects and store in such a system under a Nexus 1110. Thereby he may refer it to his car, in the future. As with all Nexes 1110, it is also possible to refer the car on Nexus 1110 before this was explicitly created. If this is “filled” later, then it retroactively adapts to all references.

Nexes 1110 can also be alternatively versioned. Furthermore, Nexes 1110 may also contain validation data. For example, a car A was found by xx-yx-owned by a user, followed by car B. Such a system can now determine the opinion of user based on the data if the user refers to his car. Similar to versions and validation data, this procedure may also be applied to other properties.

Another feature of the nexus node system 1100 is the characteristic that references/hyperlinks to Nexus node system 1100 must not be specified by an absolute URL. For instance, this may be a specially adapted language. “#{my:car}”, “# my:car” or similar syntax may imply that own car is preferred and will automatically refer to the appropriate nodes in the Nexus node system 1100. It is possible by means of the system to automatically detect who wrote the text and thus associate with “my”. Other Namespaces may also be found. For example, name of friends “#friendname: car” or “#clothes:jeans:levis501” or others. It is particularly preferred that such resources be customized for different languages and regions so that the users can easily learn and use. It can also contain constructs referring to a normal text, for example, in which this is specified or detected and will be automatically stored by a hyperlink.

Examples of using of this system: I went with #{my:car} the {#loc:supermarket near palm beach}

This sentence can now automatically refer to suitable Nexes and therefore also on the supermarket and the car of the author by means of a Nexus Node System 1100. Based on the fact that many users will often refer to the same things, this system may also have resources for assistance. Such resources of assistance can be suggestion lists, similar to Google suggest, if a user wants to create links with/on the Nexus system 1100.

It is to be noted that the recommended syntax is only for example purpose and Namespaces are not absolutely necessary. Similarly, the implementation of a Nexus Node system 1100 uses already existing similar systems. For instance, Nexes 1110 can be created for Hashtags by Twitter, for instance. This allows hashtags to mark not only words but also refer the information associated with it.

The links or document 10 required Nexes 1110 can also be stored in Nexes 1110 or by other resources in Nexus Node system 1100.

The barcode (example: http://de.wikipedia.org/wiki/2DBarcode) is generated for individual Nexes 1110 based on the characteristics of Nexus Node system 1100. This can be printed by the user and adhere to their items. The objects can be again recognized in new images by the barcodes and thus easier to analyze by programs or other resources as well as allocating Nexes 1110.

Another feature of this system is the option to quantify references in the system. It is also possible to form one or several schemata 120 introduced in document 10 by different references. Thus, other resources described in this invention can be used in the Nexus Node System 1100. Furthermore, advertisements may be associated to these systems with advertising through references or Nexes 1110.

In addition to this, a Nexus Node system 1100 can be coupled with a hyperadapter, or used together. Especially with the YourWeb variant.

1. A So-ad-tec system to access advertisement and/or associated information that is stored the So-ad-tec system (100) comprises:
a. an access unit designed to process at least one access, wherein the access includes resources which serve to access an information of at least one schema, or details derived from the schema, or an structure of the schema;
b. wherein the So-ad-tec system is designed to manage an advertisement and other information associated or related to the advertisement.

2. The system according to claim 1, wherein the So-ad-tec system is designed to use the resources included in the access document to modify the result of access, wherein the result are present in the So-ad-tec system, which are used in at least one further access.

3. The system according to claim 1, wherein the So-ad-tec system is designed to store the resources specified in an access document into an internal memory and apply them in at least one other access.

4. The system according to claim 1, wherein the So-ad-tec system has at least one schema containing a hierarchy.

5. The system according to claim 1, wherein the So-ad-tec system has at least one resource which makes it easier to mark products in documents, wherein the marking is done by other user, external resources and the data relating to markings in So-ad-tec Systems is stored in at least one system.

6. The system according to claim 1, wherein the So-ad-tec system receives and processes access documents, contains references to context data or context data itself and is use to determine the advertisement on the basis of this.

7. The system according to claim 1, wherein the context data contains at least one day or/and other markings or assignments generated by the user, with possibly associated ratings or with other properties on the information about these assignments or markings, which can be used for access.

8. The system according to claim 1, wherein the So-ad-tec system considers an user information in the access.

9. The system according to claim 1, wherein the So-ad-tec system enables considering the context data and user data with the access.

10. The system according to claim 1, wherein the So-ad-tec system stores responses or/and the information of users, and this is used to generate result.

11. The system according to claim 1, wherein the So-ad-tec system is use to deliver at least one advertisement to the user or to make it accessible.

12. The system according to claim 1, As per the previous claims, wherein the So-ad-tec system is use to structure further or/and alternative data as advertisement in a schema (120) wherein the So-ad-tec system further includes:
a) at least one schema, which can be adjusted by various resources and settings can be activated by resources in one or several access documents or/and in the So-ad-tec system;
b.) whereby the resources for adjustment are parameterized or modified by one or several access documents and the schema is used in at least one further access.

13. A method for accessing advertising or/and the information associated with it can be stored in a So-ad-tec system, wherein the method comprises the steps of:
a. processing at least one access document, wherein the access document contains resources in the form of documents that may be used to access information from a schema or/and an information derived thereof or the schema, or its structure and the schema is a document;
b. wherein in the processing step the schema contains advertisements and other related or logically associated in at least one schema.

14. The method as per claim 13, further comprising the steps of receiving information by at least one access document and the return of a result at least one result, wherein the result includes at least one information related to the advertising.

15. A computer program exhibiting instructions to implement methods according to claim 13.
